(19) United States
(12) Patent Application Publication
(10) Pub. No.: US 2009/0068532 A1
(43) Pub. Date: Mar. 12, 2009

(54) SOLID OXIDE TYPE FUEL CELL AND METHOD FOR MANUFACTURING THE SAME

(75) Inventors: Michio HORIUCHI, Nagano-shi (JP); Shigeaki Suganuma, Nagano-shi (JP); Jun Yoshiike, Nagano-shi (JP); Yasue Tokutake, Nagano-shi (JP); Fumimasa Katagiri, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD., NAGANO-SHI (JP)

(21) Appl. No.: 12/201,314

(22) Filed: Aug. 29, 2008

(30) Foreign Application Priority Data
Aug. 30, 2007 (JP) 2007-224463

(51) Int. Cl. H01M 8/10; H05H 1/26

(52) U.S. Cl. 429/33; 427/454

(57) ABSTRACT

The fuel cell uses a solid oxide as an electrolyte and includes a cell main body. The cell main body, which includes an anode layer, an electrolyte layer and a cathode layer, is formed on a mesh conductor according to a plasma spraying method. Atmospheres respectively in contact with the anode and cathode layers are operated according a method in which they are isolated from each other. The method for manufacturing the solid type fuel cell is characterized in that an anode composition, an electrolyte composition and a cathode composition are plasma sprayed onto the mesh conductor sequentially in this order.

### BACKGROUND OF THE INVENTION

The present invention relates to a solid oxide type fuel cell using a solid oxide as an electrolyte and a method for manufacturing the same.

Generally, since a solid oxide type fuel cell is operated according to a method in which an oxygen containing gas and a fuel gas are isolated from each other, the main body of the fuel cell, which includes an anode layer, an electrolyte layer and a cathode layer, must have a structure that at least the electrolyte layer thereof is formed airtight enough to isolate the gases from each other. Therefore, the respective layers of the cell main body must be highly dense and, when forming them, it takes a long time in the order of several weeks to burn them, which inevitably results in the high costs thereof.

On the other hand, as a method for forming the solid oxide layer in a short time at a low cost, there is known a plasma spraying method. However, the plasma-spray formed layer has not enough denseness to realize the above-mentioned gas isolation.

In the below-cited patent reference 1, there is disclosed a method in which a green sheet made of the material composition of a solid oxide is placed on a mesh metal and is then burned. However, this method also requires a long time process and cannot reduce the cost either.

In the below-cited patent reference 2, there is disclosed a technology in which an anode layer, an electrolyte layer and a cathode layer are formed on a mesh-shaped carrier structure portion according to a spraying method. However, a main body of a fuel cell, which is constituted by these three layers, is of a type that it is operated while an oxygen containing gas and a fuel gas are isolated from each other. In this case, at least the electrolyte layer of the three layers must be formed as an airtight layer. Therefore, all of the three layers cannot be formed by spraying.

### [Patent Reference 1] JP-A-2004-139936

### [Patent Reference 2] JP-A-2004-529477

### SUMMARY OF THE INVENTION

It is an object of the invention to provide a solid oxide type fuel cell which can be manufactured at a low cost according to a simple process not requiring a long time, and a method for manufacturing the same.

In attaining the above object, according to a first aspect of the invention, there is provided a solid oxide type fuel cell including:

an electrolyte made of a solid oxide, and

a main body of the fuel cell including an anode layer, an electrolyte layer and a cathode layer, the main body being formed on a mesh conductor using plasma spraying, wherein

the fuel cell is operated according to a method in which atmospheres respectively in contact with the anode and cathode layers are not isolated from each other.

According to a second aspect of the invention, there is provided the solid oxide type fuel cell as set forth in the first aspect, wherein

the method is a method for applying the flame of a fuel directly to the anode layer, or a method for supplying a mixed gas including an oxygen containing gas and a fuel gas to the anode and cathode layers in common.

According to a third aspect of the invention, there is provided the solid oxide type fuel cell as set forth in the first or second aspect, wherein

at least one of the anode and cathode layers of the cell main body is formed in such a manner that at least a portion thereof is embedded in the mesh conductor.

According to a forth aspect of the invention, there is provided the solid oxide type fuel cell as set forth in any one of the first to third aspects, wherein

a portion of the mesh conductor extends up to the outside of the cell main body.

According to a fifth aspect of the invention, there is provided the solid oxide type fuel cell as set forth in any one of the first to forth aspects, wherein

the respective plane areas of the anode and cathode layers are contained inside the plane area of the electrolyte layer.

According to a sixth aspect of the invention, there is provided a method for manufacturing a solid oxide type fuel cell as set forth in any one of the first to fifth aspects, including:

a step of executing of plasma spraying an anode composition, an electrolyte composition and a cathode composition onto a mesh conductor sequentially in this order.

According to a seventh aspect of the invention, there is provided the method as set forth in the sixth aspect, wherein

the plasma spraying of the cathode composition is divided in two to a first plasma spraying and a second plasma spraying,

after execution of the first plasma spraying, a second mesh conductor is placed on the plasma-spray-formed layer, and

the second plasma spraying is executed from above the second mesh conductor.

According to an eighth aspect of the invention, there is provided the method asset forth in the fifth or sixth aspect, wherein

the plasma spraying is executed in such a manner that a shield plate is arranged behind the mesh conductor when viewed from the plasma spraying direction.

A solid oxide type fuel cell according to the invention is operated according to a method in which two atmospheres respectively in contact with the anode and cathode layers are not isolated from each other. Therefore, none of the anode layer, electrolyte layer and cathode layer requires airtightness, that is, denseness but the fuel cell can be operated properly according to a porous structure which can be formed by plasma spraying. This makes it possible to manufacture the fuel cell at a low cost according to a short-time and simple process.

### BRIEF DESCRIPTION OF THE DRAWINGS

FIGS. 1(1) and 1(2) show the two types of a unit cell of a solid oxide type fuel cell according to the invention: Specifically, FIG. 1(A) is a plan view thereof; and, FIG. 1(B) is a section view thereof.

FIG. 2 is a section view of a module including a plurality of series connected unit cells of the type shown in FIG. 1(1)

FIG. 3 is a section view of an example of a structure in which the module shown in FIG. 2 is applied to a power generation system using a direct flame method.

FIG. 4 is a picture of an anode layer formed by plasma spraying nickel onto a nickel mesh, taken by a scanning electron microscope.

FIGS. 5(1) and 5(2) are pictures, taken by a scanning electron microscope, of an electrolyte layer formed when a metal mask is arranged in the state shown in FIG. 4 and SDC is plasma sprayed onto the metal mask.

FIGS. 6(1) and 6(2) are pictures, taken by a scanning electron microscope, of a state provided when a small amount of SSC is plasma sprayed onto the state shown in FIGS. 5(1) and 5(2).

FIGS. 7(1) and 7(2) are pictures, taken by a scanning electron microscope, of a cathode layer provided when a nickel-made mesh of 100 meshes is arranged in the state shown in FIGS. 6(1) and 6(2) and SSC is further plasma sprayed onto the mesh.

### DETAILED DESCRIPTION OF THE PREFERRED EMBODIMENTS

The operation method of a solid oxide type fuel cell according to the invention is a method (a direct flame method) which applies the flame of a fuel directly onto the anode layer, or a method (a mixed gas method) which supplies a mixed gas including an oxygen containing gas and a fuel gas to the anode and cathode layers in common. Neither of them requires a structure in which the oxygen containing gas and fuel gas are isolated from each other.

The former method, namely, the direct flame method is conventionally known from, for example, the disclosure of the Japanese patent publication 2004-139936, while the latter method, namely, the mixed gas method is known from, for example, the disclosure of the Japanese patent publication 2000-243412.

Here, in the latter method, that is, in the mixed gas method, it is necessary to be able to secure a big difference between the catalyst selectivity of fuel oxidation in the anode and the catalyst selectivity of oxygen reduction in the cathode. Also, use of the mixed gas raises the following restrictions. That is, both of the gas densities of the anode reaction gas and cathode reaction gas must be lower than the optimum density; and, it is always necessary to design and operate the fuel cell in such a manner that it can avoid the limit of explosion. On the other hand, the former method, that is, the direct flame method is advantageous in that it does not raise such restrictions.

Preferably, of the cell main body, at least one of the anode and cathode layers may be formed in such a manner that at least a portion thereof is embedded in a mesh conductor. More preferably, both the anode and cathode layers may be formed such that they are embedded at least partially in the mesh conductor. Owing to this, the mesh conductor can be used as a base material for plasma spraying and also as a collector, thereby being able to eliminate not only the need for provision of an additional structure for electricity collection but also the need of use of an additional processing process for such electricity collection.

Preferably, a portion of the mesh conductor may extend up to the outside of the cell main body. Owing to this, when the mesh conductor is used as a collector, the extension portion of the mesh conductor can be used as the output terminal of the cell. This can eliminate not only the need for provision of an additional structure serving as the output terminal but also the need for use of an additional processing process for such purpose. Also, when a plurality of cells are connected together in the mesh conductor extension portions respectively serving as the output terminals thereof, a cell module can be constructed easily.

Preferably, the plane areas of the anode and cathode layers may respectively be contained inside the plane area of the electrolyte layer. Owing to this, since the anode and cathode layers disposed on the two sides of the cell main body with the electrolyte layer between them can be electrically insulated from each other. This can eliminate not only the need for provision of an additional structure for insulation but also the need for use of an additional processing process for this purpose.

In a method for manufacturing a solid oxide type fuel cell according to the invention, as a basic processing process, an anode composition, an electrolyte composition and a cathode composition are plasmas sprayed onto the mesh conductor sequentially in this order. According to a typical embodiment of the invention, when a solid oxide type fuel cell according to the invention is operated according to a direct flame method, the mesh conductor may be made of a heat resisting metal such as Ni, and the anode layer may be formed on the mesh conductor. This makes it possible to secure the enhanced durability of the mesh conductor carrying thereon the anode layer which is exposed to the direct flame.

Preferably, the plasma spraying of the cathode composition may be divided in two: Specifically, after execution of the first spraying, a second mesh conductor may be placed on the plasma-spray formed layer; and, the second plasma spraying may be executed from above the second mesh conductor. Owing to this, the mesh conductor can be formed on the anode layer as well as on the cathode layer. That is, when the respective mesh conductors are used as collectors and extension portions are provided in the respective mesh conductors, there can be obtained a cell of a type that can facilitate the formation of a module.

Preferably, the plasma spraying may be executed in such a manner that a shield plate is disposed behind the mesh conductor when viewed from the spraying direction. This can control the flow of the plasma spray in the neighborhood of the mesh conductor, thereby being able to enhance the accumulation efficiency of the compositions to be plasma sprayed on the mesh conductors.

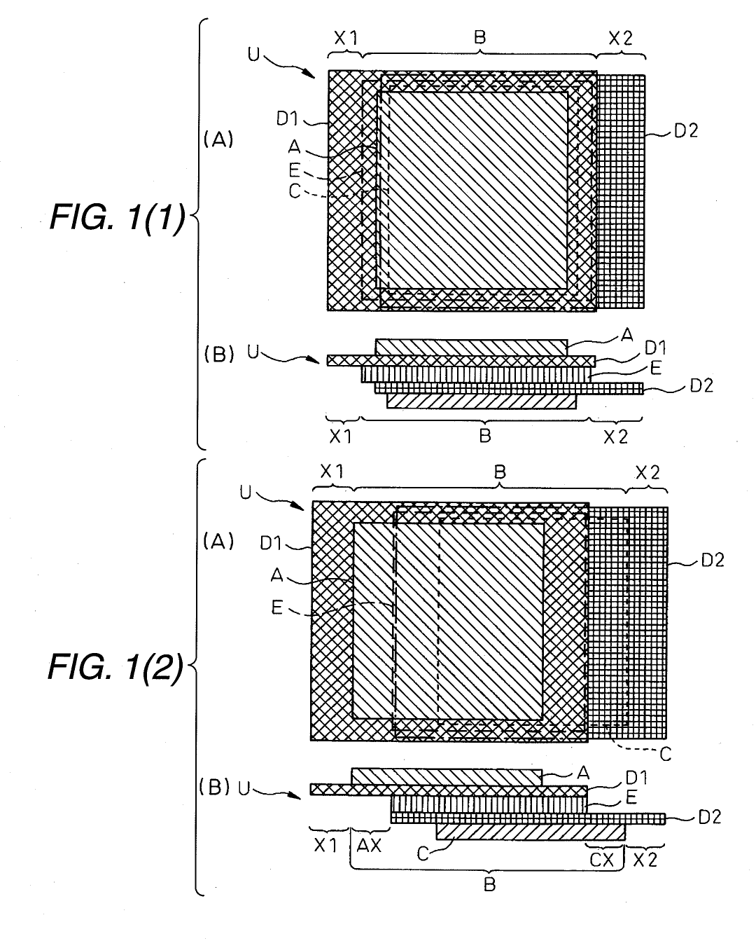

FIG. 1 shows a preferred embodiment of a solid oxide type fuel cell according to the invention.

FIGS. 1 (1) and (2) respectively show (A) a plan view and (B) a section view of a unit cell U. The cell U includes an anode layer A, a mesh conductor layer D1, an electrolyte E, a mesh conductor layer D2 and a cathode layer C which are piled up sequentially in descending order. The mesh conductor layers D1 and D2 respectively serve as collectors, while extension portions X1 and X2 extended from a cell main body B respectively function as the output terminals of the unit cell U.

To manufacture the unit cell U, according to a plasma spraying method, the anode layer A is formed, for example, on the surface of the mesh conductor D1; then, the electrolyte layer E is formed on the back surface of the mesh conductor D1; next, the mesh conductor D2 is placed onto the electrolyte layer E; and, finally, the cathode layer is formed from above the mesh conductor D2.

In the embodiment shown in FIG. 1 (1), the respective plane areas of the anode layer A and cathode layer C are contained inside the plane area of the electrolyte layer E. This embodiment is convenient when securing an electrical insulation between the anode layer A and cathode layer C. However, this is not always limitative. In the embodiment shown in FIG. 1 (2), the anode layer A, electrolyte layer E and cathode layer C have equal plane areas and are sequentially disposed slightly shifted in position from each other. Since the portions AX and CX of the anode layer A and cathode layer C respectively sticking out of the electrolyte layer E have axial symmetry with respect to the electrolyte E, there is no fear that there can easily occur a short circuit between the anode layer A and cathode layer C through the portions AX and CX.

In both types of unit cells U, since the extension portions X1 and X2 of the mesh conductors D1 and D2 stick out from the cell main body B in the mutually opposing directions, when the extension portions X1 and X2 of the mutually adjoining unit cells U are connected together, a plurality of unit cells can be connected in series, thereby being able to constitute a cell module easily.

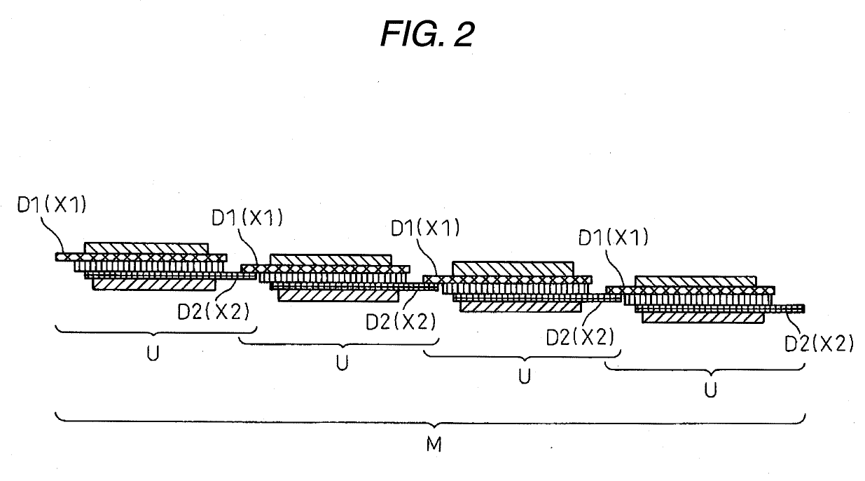

FIG. 2 shows an example of the structure of a cell module which can be formed by connecting unit cells together, in the case of the unit cell of a type shown in FIG. 1 (1). In the illustrated example, between the mutually adjoining unit cells U, the mesh conductor extension portions X1 and X2 are connected together to connect four pieces of unit cells U in series, thereby constituting a cell module M. The cell module M outputs an electromotive force four times as large as the electromotive force of the unit cell U.

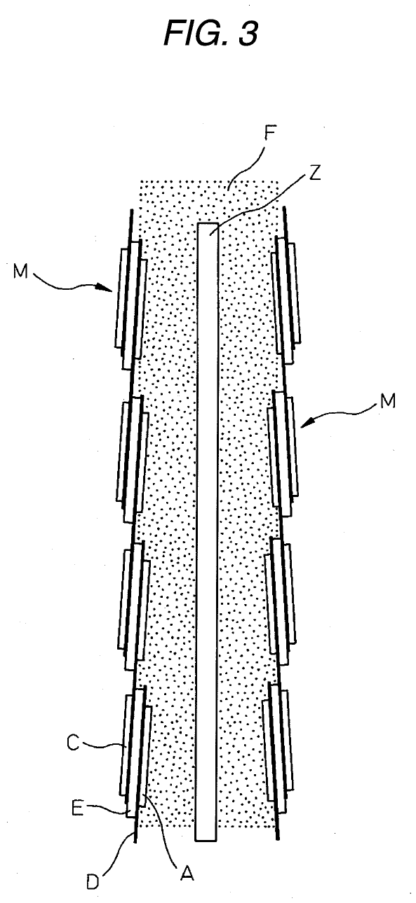

FIG. 3 shows an example of a structure obtained when the cell module M shown in FIG. 2 is used according to the direct flame method. In the illustrated example, a pair of cell modules M and M are disposed face to face with a combustion nozzle Z between them in such a manner that their respective anode layers A sides are opposed to each other, and a multiple flame F from the nozzle Z is radiated directly to the anode layers A, thereby generating power.

As the mesh conductor D, preferably, there may be used a heat resisting metal, for example, as a nickel mesh, a stainless steel mesh such as SUS 310, SUS 304 and SUS 430, and a heat resisting alloy mesh such as a hastelloy.

For the structure of the mesh, preferably, there may be used a plain weave, because the plain weave is less expensive than a twill weave and can also be easily deformed with respect to a stress.

As the electrolyte E made of a solid oxide, there can be used a known solid electrolyte which is used in a fuel cell. For example, there can be used the followings.

(a) Zirconium-system ceramics such as YSZ (yttrium stabilized zirconium), ScSZ (scandium stabilized zirconium), and materials which can be produced by doping Ce, Al or the like into one or both of the previous two materials.

(b) Cerium-system ceramics such as SDC (samarium doped cerium) and GDC (gadolinium doped cerium).

(c) LSGM (lanthanum gallate).

(d) Bismuth-oxide-system ceramics.

For a material used to form the anode layer A as well, there can be used a known material. For example, there can be used the following materials.

(a) Cermets made up of nickel and yttrium stabilized zirconium system ceramics, or scandium stabilized zirconium system ceramics, or cerium system (SDC, GDC, YDC or the like) ceramics.

(b) Cermets produced made up of nickel, cobalt, and yttrium stabilized zirconium system ceramics or cerium system ceramics.

(c) Sintered materials mainly made of (50% or more by weight to 99% or less by weight) of a conductive oxide such as a nickel oxide with a melted lithium.

(d) Materials produced by mixing about 1˜10% by weight of a metal made of a platinum-group element or the oxide thereof into the materials shown in the above articles (a), (b) and (c).

Of the above-mentioned materials, especially preferably, there may be used the materials shown in the articles (a), (b) and (c).

Since the sintered material, the main component of which is the conductive oxide, has an excellent oxidation resisting property, it can prevent the occurrence of the following phenomena caused by the oxidation of the anode layer: that is, the lowered power generating efficiency due to the increased electrode resistance of the anode layer or the failure of the power generation, and the detachment of the anode layer from the solid electrolyte layer. Also, as the conductive oxide, preferably, there may be used the above-mentioned nickel including melted lithium. Further, when a material produced by mixing a metal made of a platinum-group element or the oxide thereof into one of the materials shown in the above articles (a), (b) and (c) is used, there can be provided a high power generating performance.

For the cathode C as well, there can be used known materials. For example, the following materials can be used. That is, the compounds of the elements belonging to the third group of the periodic table such as lanthanum and samarium with strontium (Sr) added thereto; specifically, a manganese oxide (for example, a lanthanum strontium manganite), a gallium oxide compound, or a cobalt oxide compound (for example, a lanthanum strontium cobaltite, a samarium strontium cobaltite), or a ferrite system compound (for example, a lanthanum strontium cobalt ferrite).

### EMBODIMENT

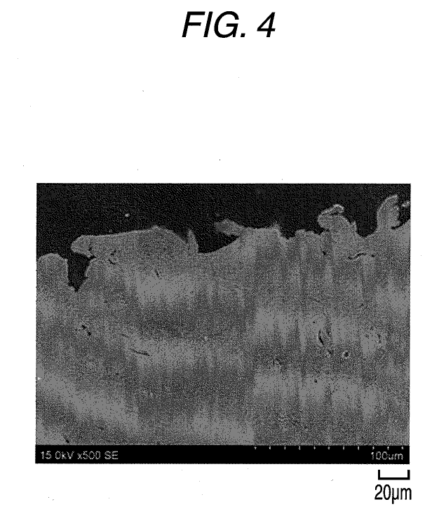

As a mesh conductor, nickel powder of a #200 mesh pass is plasma sprayed onto a nickel-made mesh of 100 meshes to thereby form an anode layer (FIG. 4).

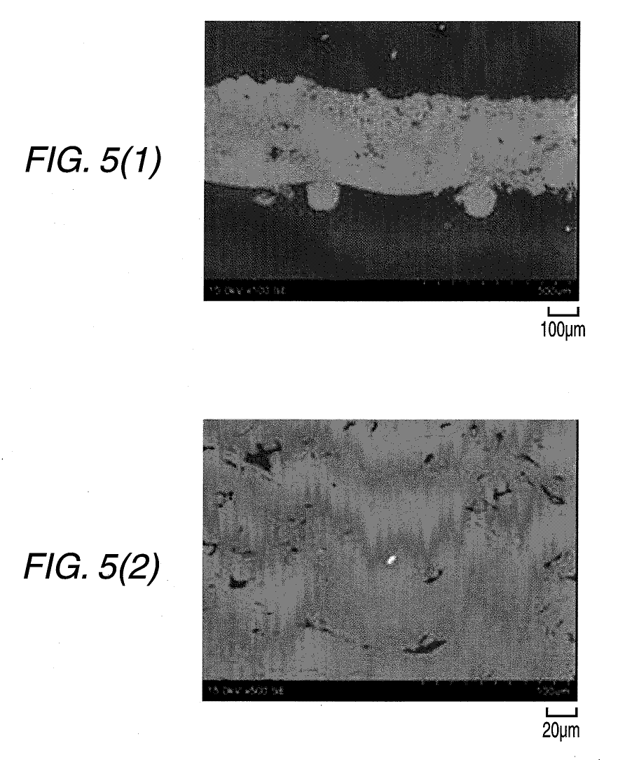

Next, a metal mask is put on the thus formed mesh conductor, and SDC (samarium doped cerium) powder of a #200 mesh pass is plasma sprayed onto the metal mask to thereby form an electrolyte layer (FIGS. 5(1) and 5(2)).

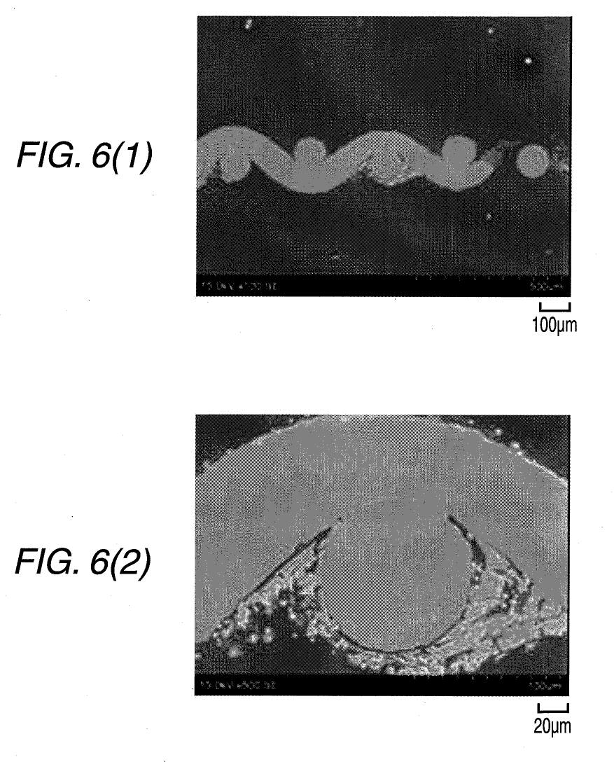

And, similarly, a small amount of SSC (samarium strontium cobaltite) is plasma sprayed onto the above-formed electrolyte layer (FIGS. 6(1) and 6(2)).

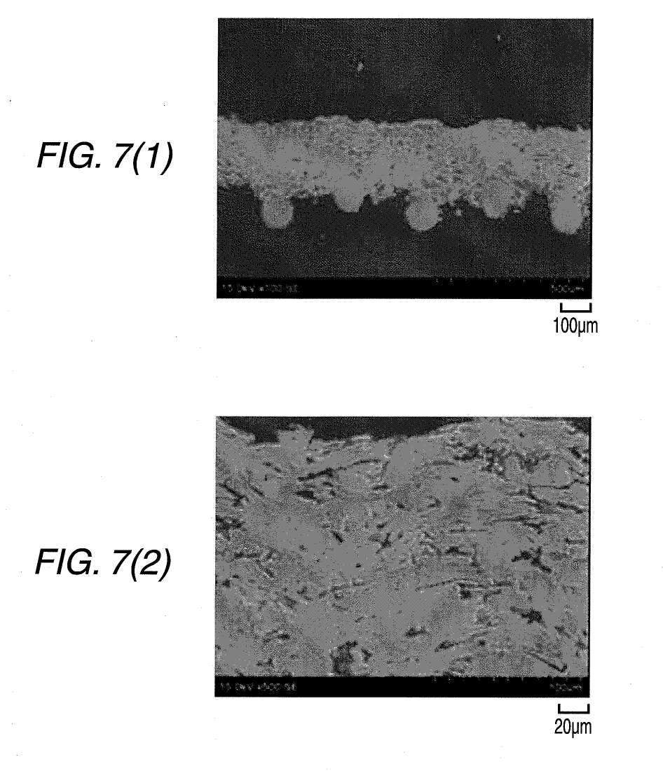

After then, a nickel-made mesh of 100 meshes is placed on the above product and SSC is further plasma sprayed from above it to thereby form a cathode layer (FIGS. 7(1) and 7(2)).

As shown in the pictures of the above figures, each of the layers formed using plasma spraying has a structure which includes a large number of pores. However, provided that there is used a power generating method such as a direct flame method or a mixed gas method in which atmospheres respectively in contact with an anode and a cathode are not isolated from each other, there can be secured a power generating reaction with no trouble.

According to the invention, there can be provided a solid oxide type fuel cell which can be manufactured at a low cost using a simple process not requiring a long time, and a method for manufacturing the same.

What is claimed is:

1. A solid oxide type fuel cell comprising:
an electrolyte made of a solid oxide, and
a main body of the fuel cell including an anode layer, an electrolyte layer and a cathode layer, the main body being formed on a mesh conductor using plasma spraying, wherein
the fuel cell is operated according to a method in which atmospheres respectively in contact with the anode and cathode layers are not isolated from each other.

2. The solid oxide type fuel cell as set forth in claim 1, wherein
the method is a method for applying the flame of a fuel directly to the anode layer, or a method for supplying a mixed gas including an oxygen containing gas and a fuel gas to the anode and cathode layers in common.

3. The solid oxide type fuel cell as set forth in claim 1, wherein
at least one of the anode and cathode layers of the cell main body is formed in such a manner that at least a portion thereof is embedded in the mesh conductor.

4. The solid oxide type fuel cell as set forth in claim 1, wherein
a portion of the mesh conductor extends up to the outside of the cell main body.

5. The solid oxide type fuel cell as set forth in claim 1, wherein
the respective plane areas of the anode and cathode layers are contained inside the plane area of the electrolyte layer.

6. A method for manufacturing a solid oxide type fuel cell as set forth in claim 1, comprising:
a step of executing of plasma spraying an anode composition, an electrolyte composition and a cathode composition onto a mesh conductor sequentially in this order.

7. The method as set forth in claim 6, wherein
the plasma spraying of the cathode composition is divided in two to a first plasma spraying and a second plasma spraying,
after execution of the first plasma spraying, a second mesh conductor is placed on the plasma-spray-formed layer, and
the second plasma spraying is executed from above the second mesh conductor.

8. The method as set forth in claim 5, wherein
the plasma spraying is executed in such a manner that a shield plate is arranged behind the mesh conductor when viewed from the plasma spraying direction.

9. The method as set forth in claim 6, wherein
the plasma spraying is executed in such a manner that a shield plate is arranged behind the mesh conductor when viewed from the plasma spraying direction.
